(19) United States
(12) Patent Application Publication
(10) Pub. No.: US 2017/0237939 A1
(43) Pub. Date: Aug. 17, 2017

(54) LOOP FILTERING FOR MULTIFORM TRANSFORM PARTITIONING

(71) Applicant: Google Inc., Mountain View, CA (US)

(72) Inventors: Jingning Han, Santa Clara, CA (US); Yaowu Xu, Saratoga, CA (US)

(21) Appl. No.: 15/044,237

(22) Filed: Feb. 16, 2016

(51) Int. Cl. H04N 7/15; H04N 19/136; H04N 19/176; H04N 19/60; H04N 19/44; H04N 19/80

(52) U.S. Cl. CPC H04N 7/15; H04N 19/44; H04N 19/80; H04N 19/176; H04N 19/60; H04N 19/136

(57) ABSTRACT

Decoding a current frame from an encoded video stream may include identifying a current transform block for decoding the current frame, the current transform block having a first transform block size, generating a reconstructed frame corresponding to the current frame, the current transform block corresponding to a first portion of the reconstructed frame, identifying a first boundary between the first portion and a second portion of the reconstructed frame, the second portion corresponding to a first adjacent transform block that is adjacent to the current transform block, the first adjacent transform block having a second transform block size, identifying first loop filter candidates based on the first transform block size, identifying a first loop filter from the first loop filter candidates based on the second transform block size, and filtering pixels from the reconstructed frame along the first boundary using the first loop filter.

### BACKGROUND

Digital video can be used, for example, for remote business meetings via video conferencing, high definition video entertainment, video advertisements, or sharing of user-generated videos. Due to the large amount of data involved in video data, high performance compression is needed for transmission and storage. Various approaches have been proposed to reduce the amount of data in video streams, including compression and other encoding and decoding techniques. These techniques often involve transformations to and from the frequency domain.

### SUMMARY

This application relates to encoding and decoding of video stream data for transmission or storage. Disclosed herein are aspects of systems, methods, and apparatuses related to loop filters for filtering transform block boundaries of a reconstructed frame.

An aspect is a method for video decoding using loop filtering for multiform transform partitioning. Video decoding using loop filtering for multiform transform partitioning may include decoding by a processor in response to instructions stored on a non-transitory computer readable medium, a current frame from an encoded video stream. Decoding the frame may include identifying a current transform block for decoding the current frame, the current transform block having a first transform block size, generating a reconstructed frame corresponding to the current frame, the current transform block corresponding to a first portion of the reconstructed frame, identifying a first boundary between the first portion and a second portion of the reconstructed frame, the second portion corresponding to a first adjacent transform block that is adjacent to the current transform block, the first adjacent transform block having a second transform block size, identifying first loop filter candidates based on the first transform block size, identifying a first loop filter from the first loop filter candidates based on the second transform block size, and filtering pixels from the reconstructed frame along the first boundary using the first loop filter.

An aspect is a method for video decoding using loop filtering for multiform transform partitioning. Video decoding using loop filtering for multiform transform partitioning may include decoding, by a processor in response to instructions stored on a non-transitory computer readable medium, a current frame from an encoded video stream. Decoding may include identifying a current transform block for decoding the current frame, the current transform block having a first transform block size, generating a reconstructed frame corresponding to the current frame, the current transform block corresponding to a first portion of the reconstructed frame, identifying a first boundary between the first portion and a second portion of the reconstructed frame, the second portion corresponding to a first adjacent transform block that is adjacent to the current transform block, the first adjacent transform block having a second transform block size, wherein the second transform block size is smaller than the first transform block size, identifying first loop filter candidates based on the first transform block size, identifying a first loop filter from the first loop filter candidates based on the second transform block size, filtering pixels from the reconstructed frame along the first boundary using the first loop filter, identifying a second boundary between the first portion and a third portion of the reconstructed frame corresponding to a second adjacent transform block, the second adjacent transform block having a third transform block size, wherein the first boundary and the second boundary are collinear, identifying a second loop filter from the first loop filter candidates based on the third transform block size, filtering pixels from the reconstructed frame along the second boundary using the second loop filter.

An aspect is a method for video decoding using loop filtering for multiform transform partitioning. Video decoding using loop filtering for multiform transform partitioning may include decoding, by a processor in response to instructions stored on a non-transitory computer readable medium, a current frame from an encoded video stream. Decoding may include identifying a current transform block for decoding the current frame, the current transform block having a first transform block size, generating a reconstructed frame corresponding to the current frame, the current transform block corresponding to a first portion of the reconstructed frame, identifying a first boundary between the first portion and a second portion of the reconstructed frame corresponding to a first adjacent transform block that is adjacent to the current transform block, the first adjacent transform block having a second transform block size, wherein the second transform block size is smaller than the first transform block size, identifying first loop filter candidates based on the first transform block size, identifying a first loop filter from the first loop filter candidates based on the second transform block size, filtering pixels from the reconstructed frame along the first boundary using the first loop filter, identifying a second boundary between the first portion and a third portion of the reconstructed frame corresponding to a second adjacent transform block, the second adjacent transform block having a third transform block size, wherein the first boundary and the second boundary are collinear, identifying a second loop filter from the first loop filter candidates based on the third transform block size, filtering pixels from the reconstructed frame along the second boundary using the second loop filter, identifying a third boundary between the first portion and a fourth portion of the reconstructed frame corresponding to a third adjacent transform block, the third adjacent transform block having a fourth transform block size, wherein the first boundary and the third boundary are perpendicular, identifying a third loop filter from the first loop filter candidates based on the fourth transform block size, and filtering pixels from the reconstructed frame along the third boundary using the third loop filter.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of a computing device in accordance with implementations of this disclosure;

FIG. 2 is a diagram of a computing and communications system in accordance with implementations of this disclosure;

FIG. 3 is a diagram of a video stream for use in encoding and decoding in accordance with implementations of this disclosure;

FIG. 4 is a block diagram of an encoder in accordance with implementations of this disclosure;

FIG. 5 is a block diagram of a decoder in accordance with implementations of this disclosure;

FIG. 6 is a block diagram of a representation of a portion of a frame in accordance with implementations of this disclosure;

FIG. 7 is a block diagram of a representation of a portion of a reconstructed frame with blocks and sub-blocks having transforms of various sizes in accordance with implementations of this disclosure;

FIG. 8 is a block diagram of a representation of a portion of a reconstructed frame with blocks and sub-blocks having transforms of various sizes in accordance with implementations of this disclosure;

FIG. 9 is a flowchart diagram of a process for loop filtering boundaries of transform blocks in accordance with implementations of this disclosure.

### DETAILED DESCRIPTION

Video compression schemes may include breaking each image, or frame, into smaller portions, such as blocks, and generating an output bitstream using techniques to limit the information included for each block in the output. An encoded bitstream can be decoded to re-create the source images from the limited information. In some implementations, the information included for each block in the output may be limited by reducing spatial redundancy, reducing temporal redundancy, or a combination thereof. For example, temporal or spatial redundancies may be reduced by predicting a frame based on information available to both the encoder and decoder, and including information representing a difference, or residual, between the predicted frame and the original frame.

In some implementations, the residual information may be further compressed by transforming the residual information into transform coefficients and quantizing the transform coefficients. For example, a uniform transform size, such as a transform size equivalent to the size of the residual information or a uniform transform size smaller than the size of the residual information, may be used. However, in some implementations, using a uniform transform size may be inefficient. In some implementations, multiform transform partition coding, which may include determining one or more transform sizes for transforming the residual information by recursively determining whether a cost for using a current block size transform exceeds a cost for partitioning the current block into sub-blocks and encoding using sub-block size transforms, may be used to maximize coding efficiency. In some implementations, a reconstructed block may be generated by dequantizing and inverse transforming the encoded information. However, a reconstructed frame may have visually objectionable artifacts along the boundaries of the transform blocks.

In some implementations, loop filtering may be applied to a reconstructed frame to filter pixels along the transform block boundaries, which may reduce or eliminate the blocking artifacts, and may improve the prediction of subsequent frames in an encoder. In some implementations, a loop filter may be identified based on the transform block size corresponding to the portion of the frame being filtered. However, identifying the loop filter based on the transform block size corresponding to the portion of the frame being filtered for blocks encoded using multiform transform partition coding may be inefficient or inaccurate. Accordingly, in some implementations, for blocks encoded using multiform transform partition coding, a loop filter may be identified based on the transform block size corresponding to the portion of the frame being filtered and based on the transform block size corresponding to the portion of the frame adjacent to the portion of the frame being filtered.

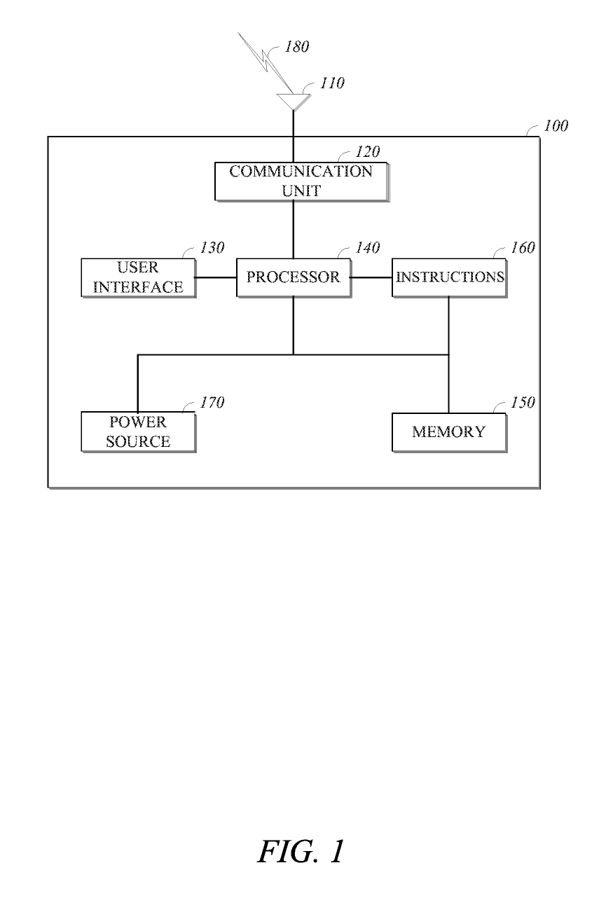

FIG. 1 is a diagram of a computing device 100 in accordance with implementations of this disclosure. A computing device 100 can include a communication interface 110, a communication unit 120, a user interface (UI) 130, a processor 140, a memory 150, instructions 160, a power source 170, or any combination thereof. As used herein, the term “computing device” includes any unit, or combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one or more element of the communication device 100 can be integrated into any number of separate physical units. For example, the UI 130 and processor 140 can be integrated in a first physical unit and the memory 150 can be integrated in a second physical unit.

The communication interface 110 can be a wireless antenna, as shown, a wired communication port, such as an Ethernet port, an infrared port, a serial port, or any other wired or wireless unit capable of interfacing with a wired or wireless electronic communication medium 180.

The communication unit 120 can be configured to transmit or receive signals via a wired or wireless medium 180. For example, as shown, the communication unit 120 is operatively connected to an antenna configured to communicate via wireless signals. Although not explicitly shown in FIG. 1, the communication unit 120 can be configured to transmit, receive, or both via any wired or wireless communication medium, such as radio frequency (RF), ultra violet (UV), visible light, fiber optic, wire line, or a combination thereof. Although FIG. 1 shows a single communication unit 120 and a single communication interface 110, any number of communication units and any number of communication interfaces can be used.

The UI 130 can include any unit capable of interfacing with a user, such as a virtual or physical keypad, a touchpad, a display, a touch display, a speaker, a microphone, a video camera, a sensor, or any combination thereof. The UI 130 can be operatively coupled with the processor, as shown, or with any other element of the communication device 100, such as the power source 170. Although shown as a single unit, the UI 130 may include one or more physical units. For example, the UI 130 may include an audio interface for performing audio communication with a user, and a touch display for performing visual and touch based communication with the user. Although shown as separate units, the communication interface 110, the communication unit 120, and the UI 130, or portions thereof, may be configured as a combined unit. For example, the communication interface 110, the communication unit 120, and the UI 130 may be implemented as a communications port capable of interfacing with an external touchscreen device.

The processor 140 can include any device or system capable of manipulating or processing a signal or other information now-existing or hereafter developed, including optical processors, quantum processors, molecular processors, or a combination thereof. For example, the processor 140 can include a special purpose processor, a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors. The processor can be operatively coupled with the communication interface 110, communication unit 120, the UI 130, the memory 150, the instructions 160, the power source 170, or any combination thereof.

The memory 150 can include any non-transitory computer-usable or computer-readable medium, such as any tangible device that can, for example, contain, store, communicate, or transport the instructions 160, or any information associated therewith, for use by or in connection with the processor 140. The non-transitory computer-usable or computer-readable medium can be, for example, a solid state drive, a memory card, removable media, a read only memory (ROM), a random access memory (RAM), any type of disk including a hard disk, a floppy disk, an optical disk, a magnetic or optical card, an application specific integrated circuits (ASICs), or any type of non-transitory media suitable for storing electronic information, or any combination thereof. The memory 150 can be connected to, for example, the processor 140 through, for example, a memory bus (not explicitly shown).

The instructions 160 can include directions for performing any method, or any portion or portions thereof, disclosed herein. The instructions 160 can be realized in hardware, software, or any combination thereof. For example, the instructions 160 may be implemented as information stored in the memory 150, such as a computer program, that may be executed by the processor 140 to perform any of the respective methods, algorithms, aspects, or combinations thereof, as described herein. The instructions 160, or a portion thereof, may be implemented as a special purpose processor, or circuitry, that can include specialized hardware for carrying out any of the methods, algorithms, aspects, or combinations thereof, as described herein. Portions of the instructions 160 can be distributed across multiple processors on the same machine or different machines or across a network such as a local area network, a wide area network, the Internet, or a combination thereof.

The power source 170 can be any suitable device for powering the communication device 110. For example, the power source 170 can include a wired power source; one or more dry cell batteries, such as nickel-cadmium (NiCd), nickel-zinc (NiZn), nickel metal hydride (NiMH), lithium-ion (Li-ion); solar cells; fuel cells; or any other device capable of powering the communication device 110. The communication interface 110, the communication unit 120, the UI 130, the processor 140, the instructions 160, the memory 150, or any combination thereof, can be operatively coupled with the power source 170.

Although shown as separate elements, the communication interface 110, the communication unit 120, the UI 130, the processor 140, the instructions 160, the power source 170, the memory 150, or any combination thereof can be integrated in one or more electronic units, circuits, or chips.

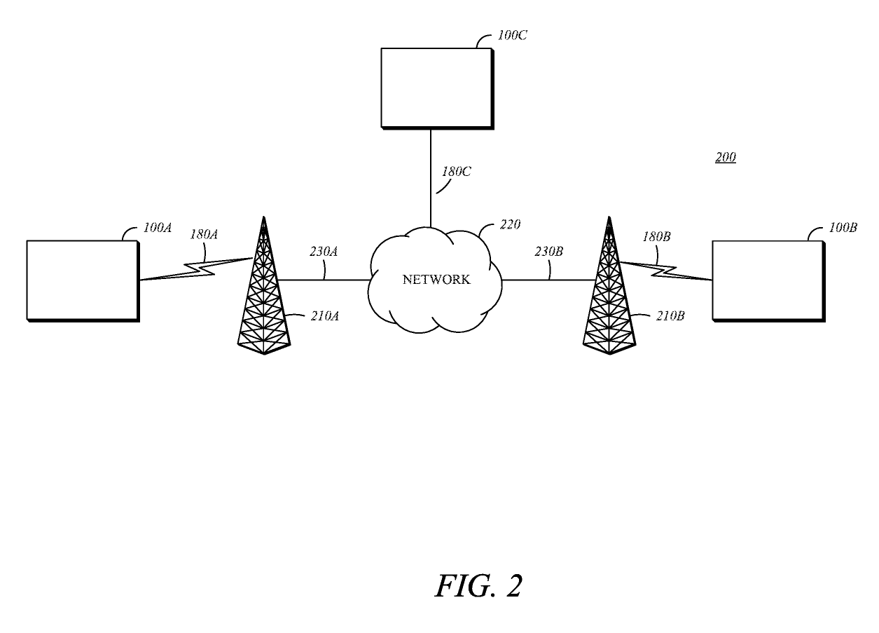

FIG. 2 is a diagram of a computing and communications system 200 in accordance with implementations of this disclosure. The computing and communications system 200 may include one or more computing and communication devices 100A/100B/100C, one or more access points 210A/210B, one or more networks 220, or a combination thereof. For example, the computing and communication system 200 can be a multiple access system that provides communication, such as voice, data, video, messaging, broadcast, or a combination thereof, to one or more wired or wireless communicating devices, such as the computing and communication devices 100A/100B/100C. Although, for simplicity, FIG. 2 shows three computing and communication devices 100A/100B/100C, two access points 210A/210B, and one network 220, any number of computing and communication devices, access points, and networks can be used.

A computing and communication device 100A/100B/100C can be, for example, a computing device, such as the computing device 100 shown in FIG. 1. For example, as shown the computing and communication devices 100A/100B may be user devices, such as a mobile computing device, a laptop, a thin client, or a smartphone, and computing and the communication device 100C may be a server, such as a mainframe or a cluster. Although the computing and communication devices 100A/100B are described as user devices, and the computing and communication device 100C is described as a server, any computing and communication device may perform some or all of the functions of a server, some or all of the functions of a user device, or some or all of the functions of a server and a user device.

Each computing and communication device 100A/100B/100C can be configured to perform wired or wireless communication. For example, a computing and communication device 100A/100B/100C can be configured to transmit or receive wired or wireless communication signals and can include a user equipment (UE), a mobile station, a fixed or mobile subscriber unit, a cellular telephone, a personal computer, a tablet computer, a server, consumer electronics, or any similar device. Although each computing and communication device 100A/100B/100C is shown as a single unit, a computing and communication device can include any number of interconnected elements.

Each access point 210A/210B can be any type of device configured to communicate with a computing and communication device 100A/100B/100C, a network 220, or both via wired or wireless communication links 180A/180B/180C. For example, an access point 210A/210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A/210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the Hyper Text Transport Protocol (HTTP), or a combination thereof.

The computing and communication devices 100A/100B/100C can communicate with each other via the network 220 using one or more a wired or wireless communication links, or via a combination of wired and wireless communication links. For example, as shown the computing and communication devices 100A/100B can communicate via wireless communication links 180A/180B, and computing and communication device 100C can communicate via a wired communication link 180C. Any of the computing and communication devices 100A/100B/100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A/210B can communicate with the network 220 via one or more types of wired or wireless communication links 230A/230B. Although FIG. 2 shows the computing and communication devices 100A/100B/100C in communication via the network 220, the computing and communication devices 100A/100B/100C can communicate with each other via any number of communication links, such as a direct wired or wireless communication link.

Other implementations of the computing and communications system 200 are possible. For example, in an implementation the network 220 can be an ad-hock network and can omit one or more of the access points 210A/210B. The computing and communications system 200 may include devices, units, or elements not shown in FIG. 2. For example, the computing and communications system 200 may include many more communicating devices, networks, and access points.

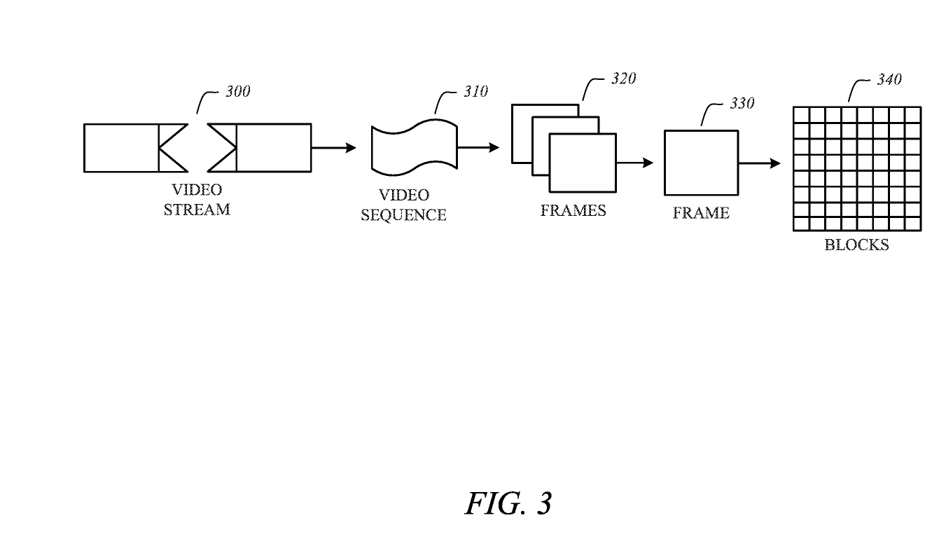

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320. Each frame 330 from the adjacent frames 320 may represent a single image from the video stream. A frame 330 may include blocks 340. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

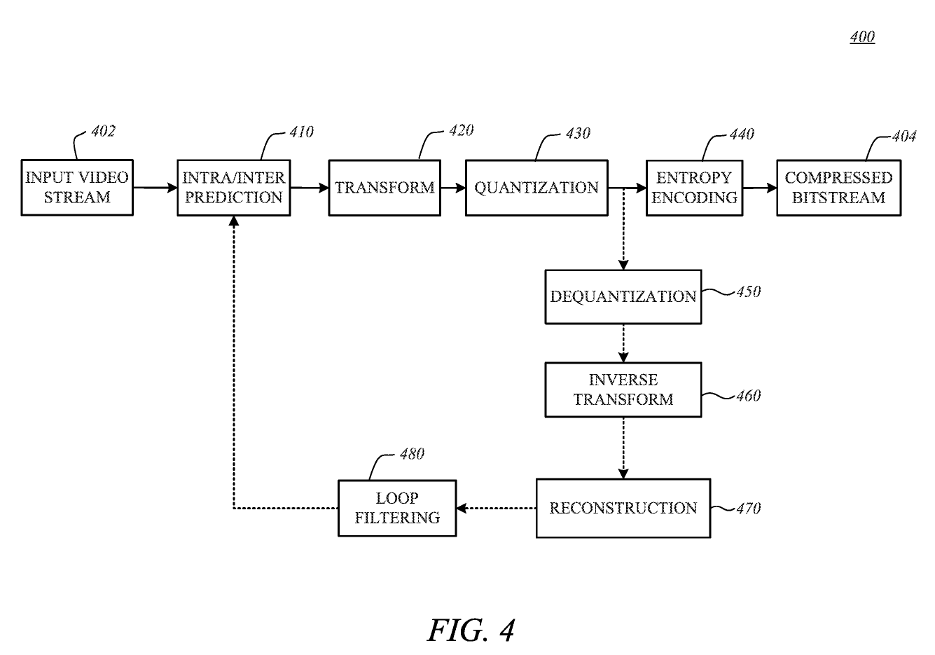

FIG. 4 is a block diagram of an encoder 400 in accordance with implementations of this disclosure. Encoder 400 can be implemented in a device, such as the computing device 100 shown in FIG. 1 or the computing and communication devices 100A/100B/100C shown in FIG. 2, as, for example, a computer software program stored in a data storage unit, such as the memory 150 shown in FIG. 1. The computer software program can include machine instructions that may be executed by a processor, such as the processor 160 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3 to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a loop filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference block in the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loéve Transform (KLT), the Discrete Cosine Transform (DCT), and the Singular Value Decomposition Transform (SVD). In an example, the DCT may include transforming a block into the frequency domain. The DCT may include using transform coefficient values based on spatial frequency, with the lowest frequency (i.e. DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

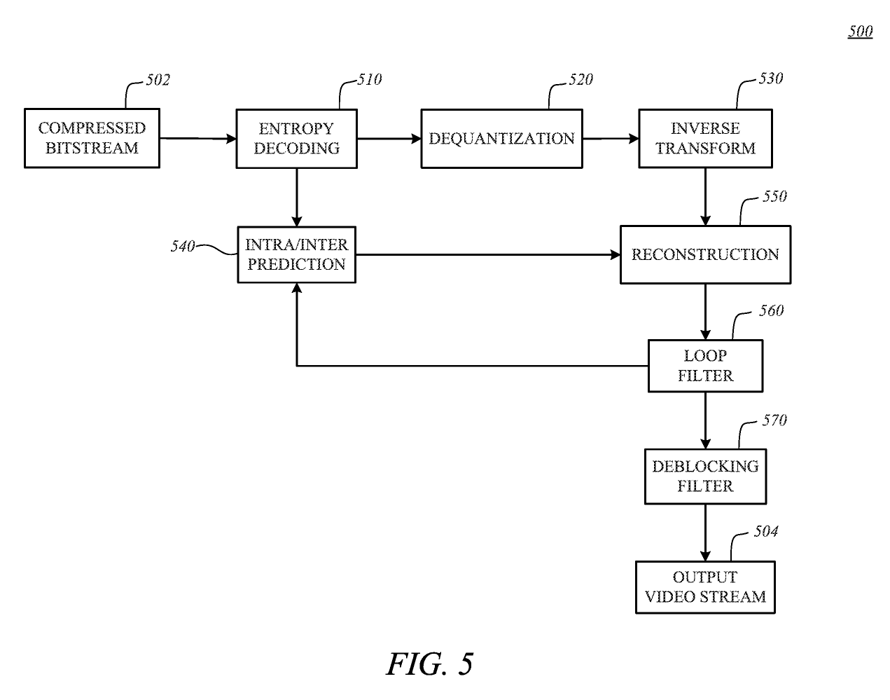

The reconstruction path can be used to maintain reference frame synchronization between the encoder 400 and a corresponding decoder, such as the decoder 500 shown in FIG. 5. The reconstruction path may be similar to the decoding process discussed below, and may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a reconstructed block. The loop filtering unit 480 can be applied to the reconstructed block to reduce distortion, such as blocking artifacts.

Other variations of the encoder 400 can be used to encode the compressed bitstream 404. For example, a non-transform based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A/100B/100C shown in FIG. 2, as, for example, a computer software program stored in a data storage unit, such as the memory 150 shown in FIG. 1. The computer software program can include machine instructions that may be executed by a processor, such as the processor 160 shown in FIG. 1, and may cause the device to decode video data as described herein. The decoder 400 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a loop filtering unit 560, a deblocking filtering unit 570, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond with the derivative residual block generated by the inverse transformation unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a reconstructed block. The loop filtering unit 560 can be applied to the reconstructed block to reduce blocking artifacts. The deblocking filtering unit 570 can be applied to the reconstructed block to reduce blocking distortion, and the result may be output as the output video stream 504.

Other variations of the decoder 500 can be used to decode the compressed bitstream 502. For example, the decoder 500 can produce the output video stream 504 without the deblocking filtering unit 570.

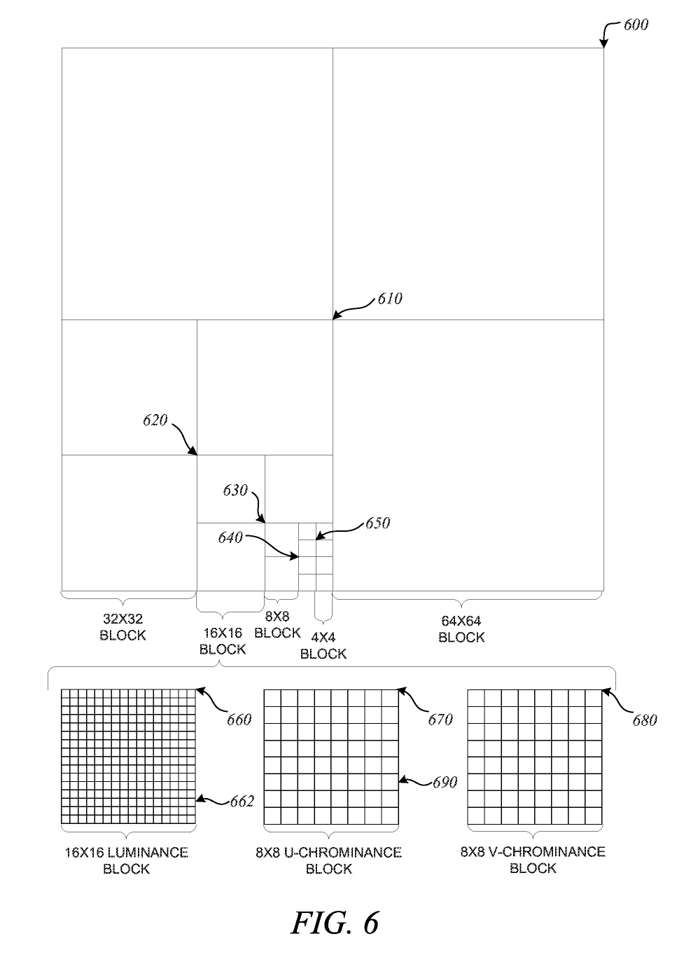

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610 (64 pixels×64 pixels), in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670/680, such as a U or Cb chrominance block 670, and a V or Cr chrominance block 680. The chrominance blocks 670/680 may include chrominance pixels 690. For example, the luminance block 660 may include 16×16 luminance pixels 662 and each chrominance block 670/680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame, and using a relatively small amount of information to represent each corresponding chrominance component for the portion of the frame. For example, a portion of a frame may be represented by a high resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different portion, and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a block or pixel in a reference frame, or a portion of the reference frame, that corresponds with a current block or pixel of a current frame. For example, a reference frame, or a portion of a reference frame, which may be stored in memory, may be searched for the best block or pixel to use for encoding a current block or pixel of the current frame. For example, the search may identify the block of the reference frame for which the difference in pixel values between the reference block and the current block is minimized, and may be referred to as motion searching. In some implementations, the portion of the reference frame searched may be limited. For example, the portion of the reference frame searched, which may be referred to as the search area, may include a limited number of rows of the reference frame. In an example, identifying the reference block may include calculating a cost function, such as a sum of absolute differences (SAD), between the pixels of the blocks in the search area and the pixels of the current block.

In some implementations, the spatial difference between the location of the reference block in the reference frame and the current block in the current frame may be represented as a motion vector. The difference in pixel values between the reference block and the current block may be referred to as differential data, residual data, or as a residual block. In some implementations, generating motion vectors may be referred to as motion estimation, a pixel of a current block may be indicated based on location using Cartesian coordinates as f_{x,y}. Similarly, a pixel of the search area of the reference frame may be indicated based on location using Cartesian coordinates as r_{x,y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two dimensional data structure such as a matrix as shown, or in a one dimensional data structure, such as a vector array. In an implementation, a representation of the frame, such as a two dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties, and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block based coding efficiency may be improved by partitioning a current residual block into one or more transform partitions, which may be rectangular, including square, partitions for transform coding. In some implementations, video coding using transform partitioning may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks having 32×32 transform coefficients, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding using transform partitioning may include identifying multiple transform block sizes for a residual block using multiform transform partition coding. In some implementations, multiform transform partition coding may include recursively determining whether to transform a current block using a current block size transform or by partitioning the current block and multiform transform partition coding each partition.

For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 partitions 620, and multiform transform partition coding each partition.

In some implementations, determining whether to transform partition the current block may be based on comparing a cost for encoding the current block using a current block size transform to a sum of costs for encoding each partition using partition size transforms.

For example, for the bottom-left 64×64 block 610 shown, the cost for encoding the 64×64 block 610 using a 64×64 size transform may exceed the sum of the costs for encoding four 32×32 sub-blocks 620 using 32×32 transforms. The cost for encoding the top left 32×32 sub-block 620 using a 32×32 transform may be less than a sum of the cost for encoding the top left 32×32 sub-block 620 using four 16×16 transforms, and the top left 32×32 sub-block 620 may be coded using a 32×32 transform. Similarly, the cost for encoding the top right 32×32 sub-block 620 using a 32×32 transform may be less than a sum of the cost for encoding the top right 32×32 sub-block 620 using four 16×16 transforms, and the top right 32×32 sub-block 620 may be coded using a 32×32 transform. Similarly, the cost for encoding the bottom left 32×32 sub-block 620 using a 32×32 transform may be less than a sum of the cost for encoding the bottom left 32×32 sub-block 620 using four 16×16 transforms, and the bottom left 32×32 sub-block 620 may be coded using a 32×32 transform. The cost for encoding the bottom right 32×32 sub-block 620 using a 32×32 transform may exceed a sum of the cost for encoding the bottom right 32×32 sub-block 620 using four 16×16 transforms, and the bottom right 32×32 sub-block 620 may be partitioned into four 16×16 sub-blocks 630, and each 16×16 sub-block 630 may be coded using multiform transform partition coding.

For example, for the top left 16×16 block 630 shown, the cost for encoding the 16×16 block 630 using a 16×16 size transform may exceed the sum of the costs for encoding four 8×8 sub-blocks 640 using 8×8 transforms. The cost for encoding the top right 16×16 block 630 using a 16×16 transform may be less than a sum of the cost for encoding the top right 16×16 block 630 using four 8×8 transforms, and the top right 16×16 block 630 may be coded using a 16×16 transform. Similarly, the cost for encoding the bottom left 16×16 block 630 using a 16×16 transform may be less than a sum of the cost for encoding the bottom left 16×16 block 630 using four 8×8 transforms, and the bottom left 16×16 block 630 may be coded using a 16×16 transform. The cost for encoding the bottom right 16×16 block 630 using a 16×16 transform may exceed a sum of the cost for encoding the bottom right 16×16 block 630 using four 8×8 transforms, and the bottom right 16×16 block 630 may be partitioned into four 8×8 sub-blocks 640, and each 8×8 sub-block 640 may be coded using multiform transform partition coding.

For example, for the top left 8×8 sub-block 640 shown, the cost for encoding the 8×8 sub-block 640 using an 8×8 size transform may exceed the sum of the costs for encoding four 4×4 sub-blocks 650 using 4×4 transforms. The cost for encoding the top right 8×8 sub-block 640 using an 8×8 transform may be less than a sum of the cost for encoding the top right 8×8 sub-block 640 using four 4×4 transforms, and the top right 8×8 sub-block 640 may be coded using an 8×8 transform. Similarly, the cost for encoding the bottom left 8×8 sub-block 640 using an 8×8 transform may be less than a sum of the cost for encoding the bottom left 8×8 sub-block 640 using four 4×4 transforms, and the bottom left 8×8 sub-block 640 may be coded using an 8×8 transform. The cost for encoding the bottom right 8×8 sub-block 640 using an 8×8 transform may exceed a sum of the cost for encoding the bottom right 8×8 block 640 using four 4×4 transforms, and the bottom right 8×8 sub-block 640 may be partitioned into four 4×4 sub-blocks 650, and each 4×4 sub-block 650 may be coded using multiform transform partition coding. In some implementations, the sub-block size may be a minimum transform size, such as 4×4 and multiform transform partition coding may include identifying the minimum transform size as the transform size for encoding the sub-blocks.

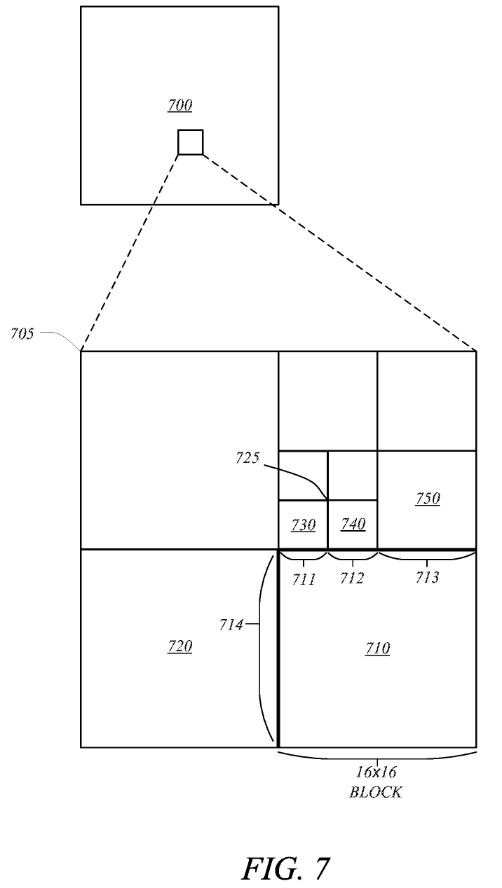

FIG. 7 is a block diagram of a representation of a portion of a reconstructed frame 700 with blocks and sub-blocks having transforms of various sizes in accordance with implementations of this disclosure. As shown in FIG. 7, block 705 is a portion of reconstructed frame 700. Block 705 is partitioned for decoding into four 16×16 sub-blocks, including blocks 710, 720 and 730. Block 730 is further partitioned into four 8×8 sub-blocks including blocks 725 and 750. Block 725 is partitioned into four 4×4 sub-blocks, including blocks 730 and 740. Each of the blocks in block 705 may also be referred to as portions of the reconstructed frame 700. In some implementations, the transform size, or corresponding transform block, may be the same size as the block size for each of the corresponding blocks and sub-blocks 710-750. For example, the transform block size for the corresponding blocks 710 and 720 is 16×16 transform coefficients. In some implementations, the transform size, or corresponding transform block, may be a different size, such as a smaller, partitioned size, compared to the corresponding blocks and sub-blocks 710-750.

The transform partitioning for block 705 as shown in FIG. 7 is multiform, which provides transform block boundaries of varying sizes along the top and left sides of block 710. A vertical transform block boundary corresponding to frame portion boundary 714 between blocks 710 and 720 may be identified by a decoder, such as the decoder 500 shown in FIG. 5. Similarly, horizontal transform block boundaries corresponding to frame portion boundaries 711, 712 and 713 may be identified by the decoder.

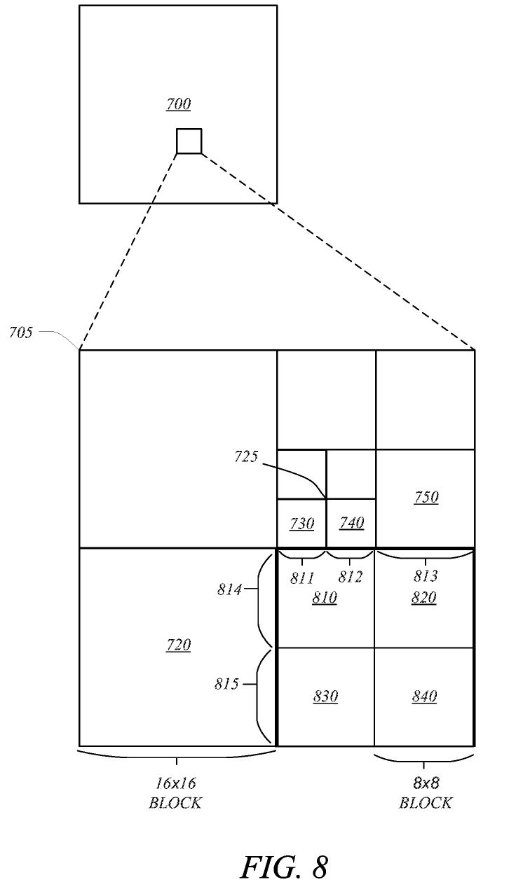

FIG. 8 is a block diagram of a variant representation of a portion of the reconstructed frame 700 shown in FIG. 7, in accordance with implementations of this disclosure. In this example representation, block 710 of FIG. 7 has been partitioned into blocks 810, 820, 830, and 840 to create frame portion boundaries 811, 812, 813, 814 and 815. The frame portion boundaries 811, 812 are collinear, horizontal boundaries, and the frame boundaries 814, 815 are collinear, vertical boundaries corresponding to block 810, and adjacent blocks 720, 730, 740. In some implementations, the transform size, or corresponding transform block, may be the same size as the block size for each of the corresponding blocks and sub-blocks 810-840, and 720-750. For example, the transform block size for each of the corresponding blocks 810/820/830/840 is 8×8 transform coefficients. In some implementations, the transform size, or corresponding transform block, may be a different size, such as a smaller, partitioned size, compared to the corresponding blocks and sub-blocks 710-750.

Loop filtering vertical and horizontal transform block boundaries, such as those corresponding to frame portion boundaries 711-714 and 811-815, may be performed by a filtering process described as follows. For simplicity and for illustrative purpose, the transform block partitioning boundaries directly correspond to the frame portion boundaries as described herein. However, this disclosure is not limited to such an implementation, and loop filtering of transform block partitioning boundaries that do not directly correspond to frame portion boundaries may be also be identified and loop filtered.

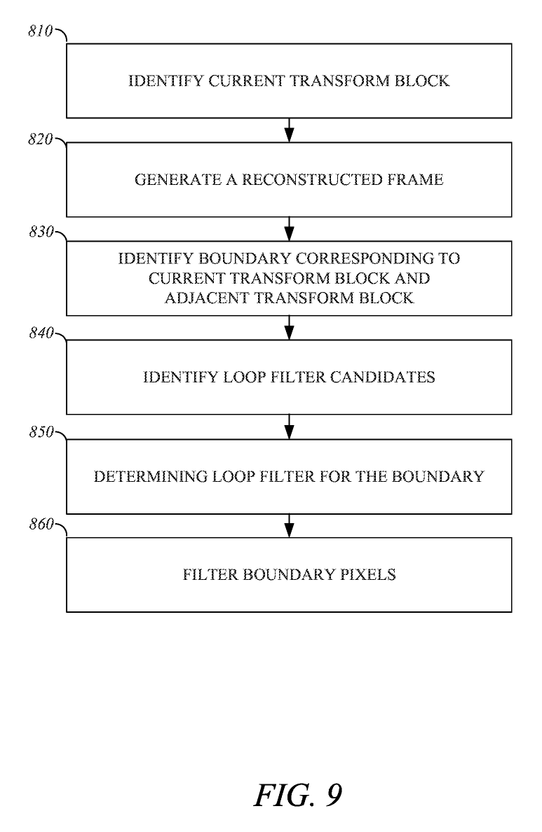

FIG. 9 is a flowchart diagram of a process for loop filtering boundaries of transform blocks in accordance with implementations of this disclosure. In some implementations, filtering using a loop filter may be implemented in and encoder, such as the encoder 400 shown in FIG. 4, or a decoder, such as the decoder 500 shown in FIG. 5. In some implementations, decoding with loop filtering transform boundaries may include identifying a current transform block at 910, generating a reconstructed frame at 920, identifying a boundary corresponding to a current transform block and an adjacent transform block at 930, identifying loop filter candidates at 940, determining a loop filter for the boundary at 950, filtering the boundary pixels using the loop filter at 960, or any combination thereof.

In some implementations, the encoder/decoder 400/500 may identify a current transform block at 920. In some implementations, the current transform block may be encoded using multiform transform partition coding as described herein. For example, the current transform block may be identified as a 32×32 transform block corresponding to a frame portion, such as the block 705 as shown in FIG. 7. In another example, the current transform block may be identified as a sub-block of a transform block, such as a 16×16 block corresponding to another frame portion, such as the block 710 shown in FIG. 7.

In some implementations, the encoder/decoder 400/500 may generate a reconstructed current frame from encoded of video stream based on an inverse transform at 920. For example, a reconstructed frame such as frame 700 shown in FIG. 7 may be generated. In some implementations, reconstructing a current frame includes dequanitization such as dequantization unit 450/520, and an inverse transformation such as inverse transform unit 460/530, which may use transform partitioning of various uniform sizes, multiform sizes, or a combination of both. For example, reconstructed block 705 of reconstructed frame 700 shown in FIG. 7 includes various sub-blocks by partitioning during decoding, such as blocks 710-750, each of which have a corresponding transform block (not shown) resulting from multiform partitioning used for inverse transformation.

In some implementations, identifying a reconstructed frame portion boundary at 930 corresponding to a boundary between a current transform block and an adjacent transform block may include a first pass of the block to identify vertical boundaries, and a second pass of the block to identify horizontal boundaries. For example, the identified reconstructed frame portion boundary may be vertical boundary 714 as shown in FIG. 7, between blocks 710 and 720, which may correspond to a boundary between the respective transform blocks related to the blocks 710 and 720. The size of the transform blocks may match the size of the corresponding reconstructed blocks 710 and 720, or the corresponding transforms may be partitioned to smaller sizes. As another example, a transform block may have two collinear boundaries, such as transform boundaries corresponding to frame portion boundaries 811, 812 for block 810 shown in FIG. 8.

In some implementations, identifying loop filter candidates based on the current transform block size at 940 may include reading transform partitioning information for the current transform block and determining the current transform block size. For example, a decoder, such as decoder 500 shown in FIG. 5, may determine that a current transform block size for block 710 is 16×16 based on reading transform partitioning information for block 710 as shown in FIG. 7. In an example where available loop filters are filter_16 (15-tap), filter_8 (7-tap) and filter_4 (4-tap), decoder 500 may identify the loop filter candidates as filter_16, filter_8 and filter_4, since all filters can fit within block 710 when positioned at a boundary, such as boundary 714. In another example, if the current transform block is the transform for block 740, the decoder 500 may determine the transform block size as 4×4 based on transform partitioning information, and identify loop filter candidates as filter_8 and filter_4, omitting filter_16 since filter_16 does not fit when positioned across a boundary of block 740. For example, if 15 taps are centered as a vertical column across horizontal boundary 712, at 7 pixels on either side of the boundary, the filter would exceed the width of the block 740.

In some implementations, identifying loop filter candidates based on the current transform block size at 940 may include identifying at least one of a filter_4 (such as a 4-tap), a filter_8 (such as a 7-tap) or a filter_16 (such as a 15-tap). In an example, the loop filter candidates may be determined by limiting the candidate loop filter to a maximum size filter, such as an M-tap filter, where the current transform block size is N×N pixels and N/4≦M≦N.

In some implementations, a loop filter may be determined at 950 from the loop filter candidates based on the smaller of the current transform block size and the adjacent transform block size. For example, when determining a loop filter for filtering the transform block boundary pixels corresponding to frame boundary 712 as shown in FIG. 7, the decoder 500 may determine the size of a current transform block corresponding to reconstructed block 710, determine the size of a adjacent transform block corresponding to reconstructed block 740, determine that the adjacent transform block size is smaller than a current transform block size 710, and may determine that the loop filter is either filter_8 or filter 4, based on the 4×4 transform block size for block 740.

In some implementations, the boundary pixels may be filtered at 960 using the loop filter determined at 950. For example, a decoder, such as decoder 500 shown in FIG. 5, may determine that the loop filter for boundary 712 shown in FIG. 7 is a filter_8 loop filter, then perform loop filtering across the boundary 712 with the filter_8 loop filter.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, not all elements of the methods described herein may be required to implement a method in accordance with the disclosed subject matter.

The implementations of the transmitting station 100A and/or the receiving station 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 100A and the receiving station 100B do not necessarily have to be implemented in the same manner.

Further, in one implementation, for example, the transmitting station 100A or the receiving station 100B can be implemented using a computer program that, when executed, carries out any of the respective methods, algorithms and/or instructions described herein. In addition or alternatively, for example, a special purpose computer/processor can be utilized which can contain specialized hardware for carrying out any of the methods, algorithms, or instructions described herein.

The transmitting station 100A and receiving station 100B can, for example, be implemented on computers in a real-time video system. Alternatively, the transmitting station 100A can be implemented on a server and the receiving station 100B can be implemented on a device separate from the server, such as a hand-held communications device. In this instance, the transmitting station 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 100A. Other suitable transmitting station 100A and receiving station 100B implementation schemes are available. For example, the receiving station 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
decoding, by a processor in response to instructions stored on a non-transitory computer readable medium, a current frame from an encoded video stream, wherein decoding includes:
identifying a current transform block for decoding the current frame, the current transform block having a first transform block size;
generating a reconstructed frame corresponding to the current frame, the current transform block corresponding to a first portion of the reconstructed frame;
identifying a first boundary between the first portion and a second portion of the reconstructed frame, the second portion corresponding to a first adjacent transform block that is adjacent to the current transform block, the first adjacent transform block having a second transform block size;
identifying first loop filter candidates based on the first transform block size;
identifying a first loop filter from the first loop filter candidates based on the second transform block size; and
filtering pixels from the reconstructed frame along the first boundary using the first loop filter.

2. The method of claim 1, wherein, on a condition that the second transform block size is smaller than the first transform block size:
identifying first loop filter candidates based on the first transform block size includes identifying a largest available loop filter for the first transform block size; and
on a condition that a largest available loop filter for the second transform block size is smaller than the largest available loop filter for the first transform block size, identifying the first loop filter includes omitting the largest available loop filter for the first transform block size from the first loop filter candidates.

3. The method of claim 1, wherein, on a condition that the second transform block size is smaller than the first transform block size, decoding includes:
identifying a second boundary between the first portion and a third portion of the reconstructed frame corresponding to a second adjacent transform block, the second adjacent transform block having a third transform block size, wherein the first boundary and the second boundary are collinear;
identifying a second loop filter from the first loop filter candidates based on the third transform block size; and
filtering pixels from the reconstructed frame along the second boundary using the second loop filter.

4. The method of claim 3, wherein the second transform block size and the third transform block size differ.

5. The method of claim 1, wherein decoding includes identifying a reconstructed block for decoding the current frame, the reconstructed block having a third portion within the reconstructed frame, wherein the current transform block corresponds with a first portion of the reconstructed block, and wherein a second transform block corresponds with a second portion of the reconstructed block, the second transform block having a third transform block size, wherein the first transform block size differs from the third transform block size.

6. The method of claim 5, wherein the first adjacent transform block is the second transform block.

7. The method of claim 5, wherein the second transform block has a fourth portion within the reconstructed frame, and wherein decoding includes:
identifying a second boundary between the fourth portion and a fifth portion of a second adjacent transform block in the reconstructed frame, the second adjacent transform block having a fourth transform block size;
identifying second loop filter candidates based on the third transform block size;
identifying a second loop filter from the second loop filter candidates based on the fourth transform block size; and
filtering pixels from the reconstructed frame along the second boundary using the second loop filter.

8. The method of claim 1, wherein decoding includes:
identifying a first reconstructed block for decoding the current frame, wherein the current transform block corresponds with at least a portion of the first reconstructed block; and
identifying a second reconstructed block for decoding the current frame, the second reconstructed block being adjacent to the first reconstructed block within the reconstructed frame, wherein the adjacent transform block corresponds with at least a portion of the second reconstructed block.

9. The method of claim 1, wherein decoding includes using multiform transform partition coding.

10. The method of claim 1, wherein decoding includes:
identifying a second boundary between the first portion and a third portion of the reconstructed frame corresponding to a second adjacent transform block, the second adjacent transform block having a third transform block size, wherein the first boundary and the second boundary are perpendicular;
identifying a second loop filter from the first loop filter candidates based on the third transform block size; and
filtering pixels from the reconstructed frame along the second boundary using the second loop filter.

11. A method comprising:
decoding, by a processor in response to instructions stored on a non-transitory computer readable medium, a current frame from an encoded video stream, wherein decoding includes:
identifying a current transform block for decoding the current frame, the current transform block having a first transform block size;
generating a reconstructed frame corresponding to the current frame, the current transform block corresponding to a first portion of the reconstructed frame;
identifying a first boundary between the first portion and a second portion of the reconstructed frame, the second portion corresponding to a first adjacent transform block that is adjacent to the current transform block, the first adjacent transform block having a second transform block size, wherein the second transform block size is smaller than the first transform block size;
identifying first loop filter candidates based on the first transform block size;
identifying a first loop filter from the first loop filter candidates based on the second transform block size;
filtering pixels from the reconstructed frame along the first boundary using the first loop filter;
identifying a second boundary between the first portion and a third portion of the reconstructed frame corresponding to a second adjacent transform block, the second adjacent transform block having a third transform block size, wherein the first boundary and the second boundary are collinear;
identifying a second loop filter from the first loop filter candidates based on the third transform block size; and
filtering pixels from the reconstructed frame along the second boundary using the second loop filter.

12. The method of claim 11, wherein:
identifying first loop filter candidates based on the first transform block size includes identifying a largest available loop filter for the first transform block size; and
on a condition that a largest available loop filter for the second transform block size is smaller than the largest available loop filter for the first transform block size, identifying the loop filter includes omitting the largest available loop filter for the first transform block size from the first loop filter candidates.

13. The method of claim 11, wherein the second transform block size and the third transform block size differ.

14. The method of claim 11, wherein decoding includes identifying a reconstructed block for decoding the current frame, the reconstructed block having a fourth portion within the reconstructed frame, wherein the current transform block corresponds with a first portion of the reconstructed block, and wherein a second transform block corresponds with a second portion of the reconstructed block, the second transform block having a fourth transform block size, wherein the first transform block size differs from the fourth transform block size.

15. The method of claim 14, wherein the first adjacent transform block is the second transform block.

16. The method of claim 14, wherein the second transform block has a fifth portion within the reconstructed frame, and wherein decoding includes:
identifying a third boundary between the fifth portion and a sixth portion of the reconstructed frame corresponding to a third adjacent transform block, the third adjacent transform block having a fifth transform block size;
identifying second loop filter candidates based on the fourth transform block size;
identifying a third loop filter from the second loop filter candidates based on the fifth transform block size; and
filtering pixels from the reconstructed frame along the third boundary using the third loop filter.

17. The method of claim 11, wherein decoding includes:
identifying a first reconstructed block for decoding the current frame, wherein the current transform block corresponds with at least a portion of the first reconstructed block; and
identifying a second reconstructed block for decoding the current frame, the second reconstructed block being adjacent to the first reconstructed block within the reconstructed frame, wherein the first adjacent transform block corresponds with at least a portion of the second reconstructed block.

18. The method of claim 11, wherein decoding includes using multiform transform partition coding.

19. The method of claim 11, wherein decoding includes:
identifying a third boundary between the first portion and a fourth portion of the reconstructed frame corresponding to a third adjacent transform block, the third adjacent transform block having a fourth transform block size, wherein the first boundary and the third boundary are perpendicular;
identifying a third loop filter from the first loop filter candidates based on the fourth transform block size; and
filtering pixels from the reconstructed frame along the third boundary using the third loop filter.

20. A method comprising:
decoding, by a processor in response to instructions stored on a non-transitory computer readable medium, a current frame from an encoded video stream, wherein decoding includes:
identifying a current transform block for decoding the current frame, the current transform block having a first transform block size;
generating a reconstructed frame corresponding to the current frame, the current transform block corresponding to a first portion of the reconstructed frame;
identifying a first boundary between the first portion and a second portion of the reconstructed frame corresponding to a first adjacent transform block that is adjacent to the current transform block, the first adjacent transform block having a second transform block size, wherein the second transform block size is smaller than the first transform block size;
identifying first loop filter candidates based on the first transform block size;
identifying a first loop filter from the first loop filter candidates based on the second transform block size;
filtering pixels from the reconstructed frame along the first boundary using the first loop filter;
identifying a second boundary between the first portion and a third portion of the reconstructed frame corresponding to a second adjacent transform block, the second adjacent transform block having a third transform block size, wherein the first boundary and the second boundary are collinear;
identifying a second loop filter from the first loop filter candidates based on the third transform block size;
filtering pixels from the reconstructed frame along the second boundary using the second loop filter;
identifying a third boundary between the first portion and a fourth portion of the reconstructed frame corresponding to a third adjacent transform block, the third adjacent transform block having a fourth transform block size, wherein the first boundary and the third boundary are perpendicular;
identifying a third loop filter from the first loop filter candidates based on the fourth transform block size; and
filtering pixels from the reconstructed frame along the third boundary using the third loop filter.
